(19) United States
(12) Patent Application Publication
(10) Pub. No.: US 2002/0103859 A1
(43) Pub. Date: Aug. 1, 2002

(54) Server device, method for supporting member registration, recording medium and data signal embodied in a carrier wave

(76) Inventors: Keisuke Kataoka, Kanagawa (JP); Sachiko Misumi, Tokyo (JP); Atsushi Hanai, Kanagawa (JP); Eiji Shinohara, Kanagawa (JP); Tatsuto Torikai, Kanagawa (JP); Shizuo Kamimura, Chiba (JP); Keiko Sakita, Kanagawa (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/058,082

(22) Filed: Jan. 29, 2002

(30) Foreign Application Priority Data
Jan. 29, 2001 (JP) 2001-020551

(51) Int. Cl. G06F 15/16

(52) U.S. Cl. 709/203

(57) ABSTRACT

A server sends an input form for inputting a customer ID to a customer terminal having accessed the server, in response to accessing from the customer terminal. The server receives the customer ID sent from the customer terminal in association with the sent input form. Upon retrieval of customer information corresponding to a user in association with the received customer ID, the server sets one or more corresponding items of the retrieved customer information in a member form for inputting member information. The server sends the member form wherein the one or more information items are set to the customer terminal, and stores the member information sent from the customer terminal in a member-information database.

### BACKGROUND OF THE INVENTION

1. Field of the Invention

The present invention relates to a server device and method for desirably supporting member registration and for performing e-commerce (electronic commerce) and actual sales activities in cooperation with each other, and relates also to a recording medium and data signal for realizing the above.

2. Description of the Related Art

Conventionally, it is very common in companies to perform sales activities, such as understanding the product usage of customers and demands for products and suggesting products conforming to the customers. In particular, a sales staff of a company visits each of his/her customers individually. At this time, the sales staff tries to establish reliable relationship with the customers and to understand the product usage of the customers and various demands about product items. To do this, the sales staff can suggest demanded products to the customers at just right time.

Since people now commonly use the Internet, the e-commerce is becoming in common use as well. For example, the user (a customer) operates a terminal, such as a personal computer or the like which is connectable to the Internet, to access a server (a Web site) of the companies, and browses a Web page including a product catalogue, etc. The user finds a desired product item in the product catalogue, the user then operates the terminal to input information including his/her name, address, number of items to be purchased and payment method, into a predetermined form. Then, the user sends the filled form to the server so as to purchase the desired product item.

It is common that such a Web site of the company has a membership system. In this case, to register as a member, each customer accesses the Web site in advance, and inputs required information in the Web page for registration. The Web site is accessed, and the registered information can be updated on the Web site.

However, troublesome registration procedures may be completed by those customers who have purchased product items from a sales company, etc. and have provided their personal information before, every time they intend to purchase a product item. Thus, such a member registration technique has been inconvenient both for the sales companies and customers.

That is, the customers, who have sent their personal information (customer information) to the sales companies using a postcard, facsimile, or telephone, etc., need to provide the same information for member registration. On the other side, the sales companies may repeatedly register the same information for the same customer. Further, the member information is just registered onto a Web site (a server) or a management server of the sales companies, and hence can not easily be used for the traditional sales activities. There are many product items which are sold through the e-commerce and on which good services should be provided. For such product items, a corresponding sales staff of a sales company performs actual sales activities and provide the customers with good services, thereby achieving high sales performance. However, in fact, the sales staff can hardly know every one of registered members, and can not sufficiently be aware of the product usage context of each customer and can not effectively perform sales activities.

In the case where each customer is assigned to either one of the sale staffs, the customers and their sales staff trust each other. Hence, even in the circumstances where the customers purchase product items through the e-commerce, the sales activities done by the sales staffs are very important.

Therefore, it is demanded that there should be established a method for supporting member registration and a method for supporting sales activities to be done by sales staffs.

### SUMMARY OF THE INVENTION

The present invention has been made consideration of the above. It is accordingly an object of the present invention to provide a server device, method, recording medium and data signal embodied in a carrier wave, all for appropriately supporting member registration and performing e-commerce and actual sales activities in cooperation with each other.

In order to attain the above object, according to the first aspect of the present invention, there is provided a server device comprising:

a user-information storage section which stores in advance user information regarding at least one user to be a new member of a system;

a communications section which sends an receives predetermined information to and from at least one user terminal through a communications network;

an input-form sender which sends input-form information for inputting ID (identification) information for identifying the at least one user in a predetermined ID-form, to the at least one user terminal through the communications section;

an ID-information receiver which receives the ID information from the at least one user terminal through the communications section, in association with the input-form information sent by the input-form sender;

an information acquirer which acquires the user information corresponding to the at least one user from the user-information storage section, in association with the ID information received by the ID-information receiver;

a member-form sender which sends member-form information for inputting member information in a predetermined member-form together with the user information acquired by the information acquirer, to the at least one user terminal through the communications section;

a member-information receiver which receives the member information, sent from the at least one user terminal in association with the user information and member-form information sent by the member-form sender, through the communications section; and

a member-information storage section which stores the member information received by the member-information receiver.

According to this invention, the user-information storage section stores in advance user information regarding at least one user to be a new member of a system. The communications section sends and receives predetermined information to and from a user terminal through the Internet, etc. The input-form sender sends input-form information (e.g. a Web page, etc.) for inputting ID information for identifying the user, to the user terminal through the communications section. The ID information receiver receives the ID information sent from the user terminal in association with the input-form information sent by the input-form sender, through the communications section. The information acquirer acquires the user information corresponding to the user in association with the ID information received by the ID-information receiver, from the user-information storage section. The member-form sender sends the member-form information (e.g. a Web page) for inputting the member information to the user terminal through the communications section, together with the user information acquired by the information acquirer. The member-information receiver receives the member information sent from the user terminal in association with the user information and the member-form information sent by the member-form sender, through the communications section. The member-information storage section stores the member information received by the member-information receiver. As a result, the member registration can desirably be supported, and the e-commerce and actual sales activities can be performed in cooperation with each other.

In order to attain the above object, according to the second aspect of the present invention, there is provided a server device comprising:

a user-information storage section which stores in advance user information regarding at least one user to be a new member of a system;

a communications section which sends and receives predetermined information to and from at least one user terminal and at least one sales-staff terminal which are connected with each other through a communications network;

an input-form sender which sends input-form information for inputting ID information for identifying the at least one user in a predetermined ID-input form, to the at least one user terminal through the communications section;

an ID-information receiver which receives the ID information sent from the at least one user terminal in association with the inputform information sent by the input-form sender, through the communications section;

an information acquirer which acquires the user information corresponding to the at least one user from the user-information storage section, in association with the ID information received by the ID-information receiver;

a member-form sender which sends member-form information for inputting member information in a predetermined member form together with the user information acquired by the information acquirer, to the at least one user terminal through the communications section;

a member-information receiver which receives the member information, sent from the at least one user terminal in association with the user information and the member-form information sent by the member-form sender, through the communications section;

a member-information storage section which stores the member information received by the member-information receiver; and

a member-information sender which sends the member information received by the member-information receiver to the at least one sales-staff terminal through the communications section.

According to this invention, the user-information storage section stores in advance the user information regarding the at least one user to be a new member of a system. The communications section sends and receives predetermined information to and from the user terminal and sales-staff terminal which are connected with each other through the Internet, etc. The input-form sender sends input-form information (e.g. a Web page, etc.) for inputting ID information for identifying the at least one user, to the user terminal through the communications section. The ID-information receiver receives the ID information sent from the user terminal in association with the input-form information sent by the input-form sender, through the communications section. The information acquirer acquires the user information corresponding to the user based on the ID information received by the ID-information receiver, from the user-information storage section. The member-form sender sends the member-form information (e.g. a Web page) for inputting the member information to the user terminal through the communications section, together with the user information acquired by the information acquirer. The member-information receiver receives the member information sent from the user terminal in association with the user information and the member-form information sent by the member-form sender, through the communications section. The member-information storage section stores the member information received by the member-information receiver. The member-information sender sends the member information received by the member-information receiver to the at least one sales-staff terminal through the communications section. As a result of this, the member registration can appropriately be supported, and the e-commerce and actual sales activities can be done in cooperation with each other.

Each of the input-form sender and the member-form sender may send a Web page including form information to the at least one user terminal; and

the member-information sender may send an e-mail including the member information received by the member-information receiver to the at least one sales-staff terminal.

The above-described server device may further comprise

a staff-information storage section which stores information regarding at least one sales staff, in association with the user information stored in the user-information storage section, and

wherein the information acquirer acquires the user information corresponding to the at least one user from the user-information storage section, and acquires the information regarding the at least one sales staff from the staff-information storage section, and

the member-information sender sets, as addressee, an e-mail address included in the information regarding the at least one sale staff and acquired by the information acquirer, and sends an e-mail including the member information acquired by the member-information receiver to the at least one sales staff terminal.

The above-described server device may further comprise:

a confirmation-form sender which sends confirmation-form information for confirming whether to send the member information received by the member-information receiver to the at least one sales staff, to the at least one user terminal through the communications section; and

a confirmation-information receiver which receives confirmation information sent from the at least one user terminal in association with the confirmation-form information sent by the confirmation-form sender, through the communications section, and

wherein the member-information sender sends an e-mail including the member information received by the member-information receiver to the at least one sales-staff terminal, only in a case where the confirmation-information receiver receives the confirmation information for confirming whether to send the member information to the at least one sales staff.

In order to attain the above object, according to the third aspect of the present invention, there is provided a method for supporting member registration, comprising the steps of:

sending input-form information for inputting ID information for identifying at least one user, to at least one user terminal through a communications network;

receiving the ID information sent from the at least one user terminal in association with the input-form information sent at the step of sending the input-form information;

acquiring user information corresponding to the at least one user in association with the ID information received at the step of receiving the ID information, from a first storage section which stores in advance the user information regarding the at least one user to be a new member of a system;

sending member-form information for inputting member information in a predetermined member form together with the user information acquired at the step of acquiring the user information, to the at least one user terminal;

receiving the member information sent from the at least one user terminal in association with the member-form information and user information sent at the step of sending the member form; and

storing the member information received at the step of receiving the member information, in a second storage section storing information regarding at least one member.

According to this invention, the step of sending the input-form information includes a step of sending input-form information (e.g. a Web page, etc.) for inputting the ID information for identifying the at least one user, to the user terminal through a communications network. The step of receiving the ID information includes a step of receiving the ID information sent form the user terminal, in association with the input-form information sent at the step of sending the input-form information. The step of acquiring the user information includes a step of acquiring the user information corresponding to the at least one user from a database, etc. storing in advance the user information regarding the at least one user to be a new member of a system, in association with the ID information received at the step of receiving the ID information. The step of sending the member-form information includes a step of sending the member-form information (e.g. a Web page, etc.) for inputting member information in a predetermined member form to the user terminal, together with the user information acquired at the step of acquiring the user information. The step of receiving the member information includes a step of receiving the member information sent from the at least one user terminal in association with the user information and the member-form information sent at the step of sending the member-form information. The step of storing the member information includes a step of storing the member information received at the step of receiving the member information, in a database, etc. storing information regarding at least one member. As a result, the member registration can desirably and supportively be performed, and the e-commerce and actual sales activities can be done in cooperation with each other.

In order to attain the above object, according to the fourth aspect of the present invention, there is provided a method for supporting member registration, comprising the steps of:

sending input-form information for inputting ID information for identifying at least one user in a predetermined ID form, to at least one user terminal through a communications network;

receiving the ID information sent form the at least one user terminal in association with the input-form information sent at the step of sending the input-form information;

acquiring user information corresponding to the at least one user terminal in association with the ID information received at the step of receiving the ID information, from a first storage section which stores in advance the user information regarding the at least one user to be a new member of a system;

sending member-form information for inputting member information in a predetermined member form together with the user information acquired at the step of acquiring the user information, to the at least one user terminal;

receiving the member information sent from the at least one user terminal in association with the member-form information and user information sent at the step of sending the member-form information;

storing the member information received at the step of receiving the member information, in a second storage section storing information regarding at least one member; and

sending member information received at the step of receiving the member information, to at least one sales-staff terminal through a communications network.

According to this invention, the step of sending the input-form information includes a step of sending input-form information (e.g. a Web page, etc.) for inputting ID information for identifying the at least one user, to the at least one user terminal through the Internet, etc. The step of receiving the ID information includes a step of receiving the ID information sent from the at least one user terminal in association with the input-form information sent at the step of sending the input-form information. The step of acquiring the user information includes a step of acquiring the user information corresponding to the at least one user in association with the ID information received at the step of receiving the ID information, from a database, etc. storing in advance user information regarding the at least one user to be a new member of a system. The step of sending the member-form information includes a step of sending member-form information (e.g. a Web page, etc.) for inputting member information in a predetermined member form, to the at least one user terminal, together with the user information acquired at the step of acquiring the user information. The step of receiving the member information includes a step of receiving the member information sent from the at least one user terminal in association with the user information and the member-form information sent at the step of sending the member-form information. The step of storing the member information includes a step of storing the member information received at the step of receiving the member information, in a database, etc. storing information regarding at least one member. The step of sending the member information includes a step of sending the member information received at the step of receiving the member information to at least one sales-staff terminal through the Internet, etc. As a result of this, the member registration can adequately be done, and the e-commerce and actual sales activities can be performed in cooperation with each other.

Each of the step of sending the input-form information and the step of sending the member-form information may include a step of sending a Web page including form information to the at least one user terminal; and

the step of sending the member information may include a step of sending an e-mail including the member information received at the step of receiving the member information, to the at least one sales-staff terminal.

The step of acquiring the user information may include a step of acquiring the user information corresponding to the at least one user from the first storage section storing in advance the user information and a step of acquiring information regarding at least one sales staff corresponding to the user information from a third storage section storing information regarding at least one sales staff; and

the step of sending the member information may include a step of setting, as addressee, an e-mail address included in the information regarding the sales staff and acquired at the step of acquiring the information and a step of sending an e-mail including the member information acquired at the step of receiving the member information to the at least one sales staff.

The above-described method may further comprise the steps of:

sending confirmation-form information for confirming whether to send the member information received at the step of receiving the member information to the at least one sales staff, to the at least one user terminal; and

receiving confirmation information received from the at least one user terminal in association with the confirmation-form information sent at the step of sending the confirmation-form information, and

wherein the step of sending the member information includes a step of sending an e-mail including the member information received at the step of receiving the member information to the at least one sales-staff terminal, only in a case where the confirmation information for confirming whether to send the member information to the at least one sales staff is received at the step of receiving the confirmation information.

In order to attain the above object, according to the fifth aspect of the present invention, there is provided a computer readable recording medium recording a program for controlling a computer to execute a method for supporting member registration, and the method comprising the steps of:

sending input-form information for inputting ID information for identifying at least one user, to at least one user terminal through a communications network;

receiving the ID information sent from the at least one user terminal in association with the input-form information sent at the step of sending the input-form information;

acquiring user information corresponding to the at least one user in association with the ID information received at the step of receiving the ID information, from a first storage section which stores in advance the user information regarding the at least one user to be a new member of a system;

sending member-form information for inputting member information in a predetermined member form together with the user information acquired at the step of acquiring the user information, to the at least one user terminal;

receiving the member information sent from the at least one user terminal in association with the member-form information and user information sent at the step of sending the member form; and

storing the member information received at the step of receiving the member information, in a second storage section storing information regarding at least one member.

In order to attain the above object, according to the sixth aspect of the present invention, there is provided a computer readable recording medium recording a program for controlling a computer to execute a method for supporting member registration, and the method comprising the steps of:

sending input-form information for inputting ID information for identifying at least one user in a predetermined ID form, to at least one user terminal through a communications network;

receiving the ID information sent form the at least one user terminal in association with the input-form information sent at the step of sending the input-form information;

acquiring user information corresponding to the at least one user terminal in association with the ID information received at the step of receiving the ID information, from a first storage section which stores in advance the user information regarding the at least one user to be a new member of a system;

sending member-form information for inputting member information in a predetermined member form together with the user information acquired at the step of acquiring the user information, to the at least one user terminal;

receiving the member information sent from the at least one user terminal in association with the member-form information and user information sent at the step of sending the member-form information;

storing the member information received at the step of receiving the member information, in a second storage section storing information regarding at least one member; and

sending member information received at the step of receiving the member information, to at least one sales-staff terminal through a communications network.

In order to attain the above object, according to the seventh aspect of the present invention, there is provided a computer data signal embodied in a carrier wave and representing an instruction sequence for controlling a computer to execute a method for supporting member registration, and the method comprising the steps of:

sending input-form information for inputting ID information for identifying at least one user, to at least one user terminal through a communications network;

receiving the ID information sent from the at least one user terminal in association with the input-form information sent at the step of sending the input-form information;

acquiring user information corresponding to the at least one user in association with the ID information received at the step of receiving the ID information, from a first storage section which stores in advance the user information regarding the at least one user to be a new member of a system;

sending member-form information for inputting member information in a predetermined member form together with the user information acquired at the step of acquiring the user information, to the at least one user terminal;

receiving the member information sent from the at least one user terminal in association with the member-form information and user information sent at the step of sending the member form; and

storing the member information received at the step of receiving the member information, in a second storage section storing information regarding at least one member.

In order to attain the above object, according to the eighth aspect of the present invention, there is provided a computer data signal embodied in a carrier wave and representing an instruction sequence for controlling a computer to execute a method for supporting member registration, and the method comprising the steps of:

sending input-form information for inputting ID information for identifying at least one user in a predetermined ID form, to at least one user terminal through a communications network;

receiving the ID information sent form the at least one user terminal in association with the input-form information sent at the step of sending the input-form information;

acquiring user information corresponding to the at least one user terminal in association with the ID information received at the step of receiving the ID information, from a first storage section which stores in advance the user information regarding the at least one user to be a new member of a system;

sending member-form information for inputting member information in a predetermined member form together with the user information acquired at the step of acquiring the user information, to the at least one user terminal;

receiving the member information sent from the at least one user terminal in association with the member-form information and user information sent at the step of sending the member-form information;

storing the member information received at the step of receiving the member information, in a second storage section storing information regarding at least one member; and

sending member information received at the step of receiving the member information, to at least one sales-staff terminal through a communications network.

### BRIEF DESCRIPTION OF THE DRAWINGS

The object and other objects and advantages of the present invention will become more apparent upon reading of the following detailed description and the accompanying drawings in which:

FIG. 1 is a diagram exemplarily showing one structure of a member-registration support system according to an embodiment of the present invention;

FIG. 2 is a block diagram exemplarily showing one structure of a server included in the member-registration support system of FIG. 1;

FIG. 3A is a diagram exemplarily showing information stored in a customer-information database, FIG. 3B is a diagram exemplarily showing information stored in member-information database, and FIG. 3C is a diagram exemplarily showing information stored in a staff-information database;

FIG. 4 is a flowchart for explaining a member registration process to be executed by the member-registration support system according to the first embodiment;

FIG. 5 is a diagram exemplarily showing a menu page to be sent from the server to user terminals;

FIG. 6 is a diagram exemplarily showing a customer-ID page to be sent from the server to user terminals;

FIG. 7 is a flowchart for explaining a registered-information referring process;

FIG. 8 is a diagram exemplarily showing one structure of a registered-information sending form to be sent from the server to user terminals;

FIG. 9 is a diagram exemplarily showing a notice-confirmation page to be sent from the server to user terminals; and

FIG. 10 is a flowchart for explaining an e-mail transmission process.

### DETAILED DESCRIPTION OF THE PREFERRED EMBODIMENT

A preferred embodiment of the present invention will now be described with reference to the accompanying drawings.

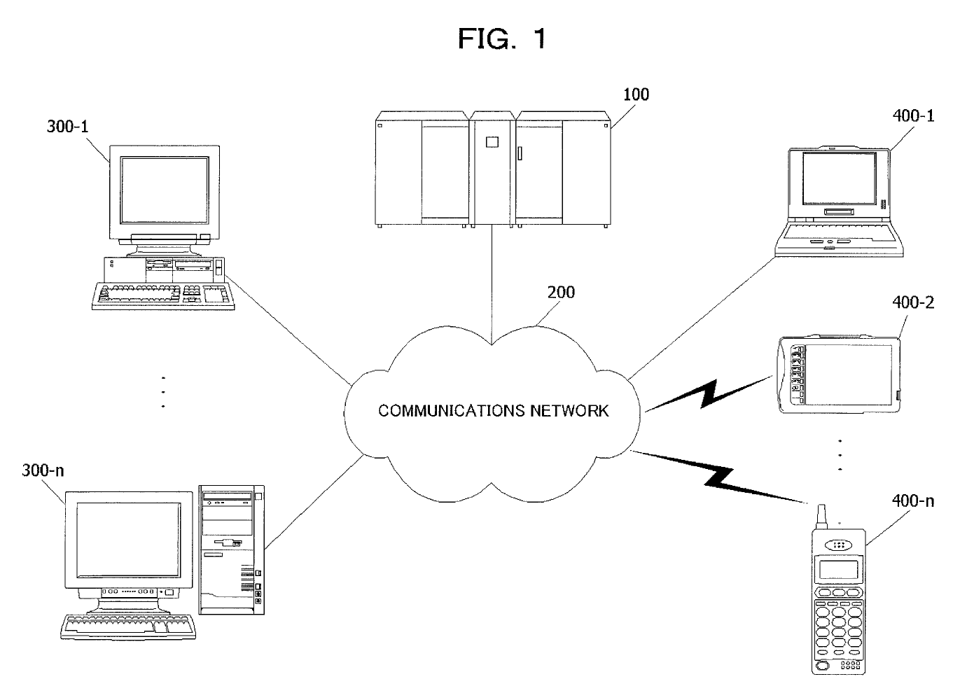

FIG. 1 is a diagram exemplarily showing one structure of a member-registration support system according to an embodiment of the present invention. As shown in FIG. 1, the member-registration support system comprises a server 100, a communications network 200, a user terminal 300 (including a plurality of user terminals 300-1 to 300-n) and a sales-staff terminal 400 (including a plurality of sales-staff terminals 400-1 to 400-n). Note that the member-registration support system is a system for dealing relatively largesized product items, such as copiers, etc.

The server 100 includes, for example, a mainframe computer, a workstation, etc., and is controlled appropriately by a sales company, or the like. The server 100 provides the user terminal 300 with product information or the like through the communications network, and informs the sales-staff terminal 400 about sales information, etc. The structure of the server 100 will more specifically be described later.

The communications network 200 includes, for example, a network, such as the Internet or the like, and connects the server 100, the user terminal 300 and the sales-staff terminal 400 with one another.

The user terminal 300 (including the plurality of terminals 300-1 to 300-n) is a terminal which is operated by a customer (a user), and includes a personal computer having a controller, a storage section and a display section and the like, or includes a portable information terminal which can receive and display Web pages. The user terminal 300 connects with the communications network 200 through a communications device, such as a modem, TA (a Terminal Adapter), and receives and sends predetermined information from and to the server 100 or the like.

A program (browser or the like) for browsing Web pages is installed in advance in the storage section of the user terminal 300. The controller (a CPU or the like) of the user terminal 300 executes the installed program, and receives Web pages provided from the server 100 through the communications network 200. The display section of the user terminal 300 displays the received Web pages, and thus letting the customer browse the Web pages.

The sales-staff terminal 400 (including the plurality of terminals 400-1 to 400-n) is a terminal which is operated by the sales staff of the sales company, etc., and includes a small personal computer, a portable information terminal, such as a PDA (Personal Data Assistants), or a cellular phone or PHS (Personal Handyphone System) which can send and receive e-mails to and from other terminals.

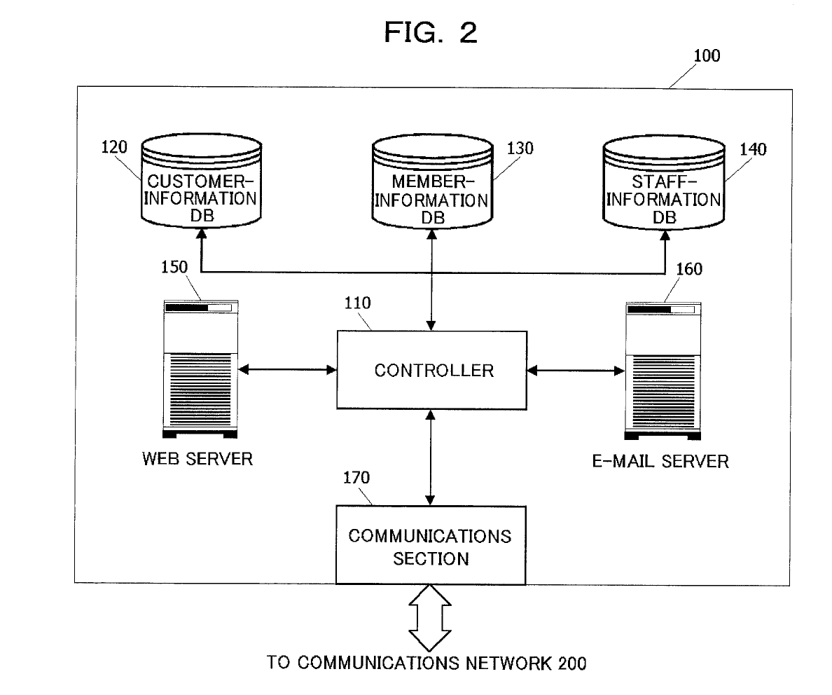

The server 100 will now specifically be described with reference to FIG. 2.

FIG. 2 is a block diagram showing an example of the structure of the server 100. As shown in FIG. 2, the server 100 comprises a controller 110, a customer-information database 120, a member-information database 130, a staff-information server 140, a Web server 150, an e-mail server 160 and a communications section 170.

The controller 110 includes a CPU (Central Processing Unit) or the like, and controls the entire operations of the server 100. Specifically, the controller 110 executes an operational program stored in a non-illustrative memory, and carries out a member registration process, as will be described later.

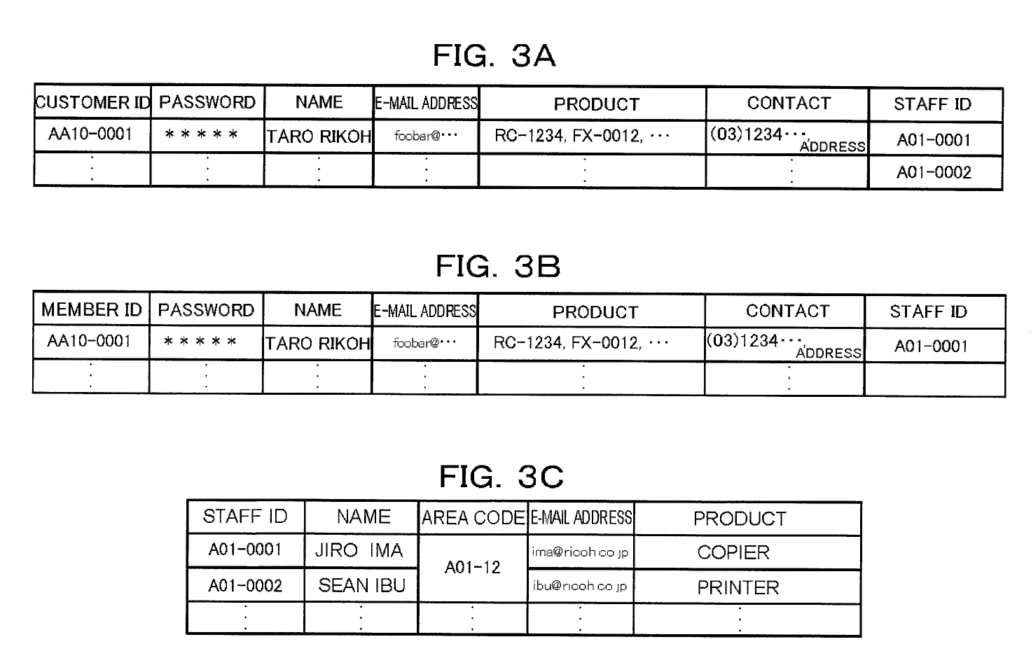

The customer-information database 120 includes a re-writable storage device, such as a hard-disk device, etc., and stores customer information shown in FIG. 3A.

As shown in FIG. 3A, the customer information includes information items of “customer ID” for identifying a customer, a “password” for authenticating the customer, a “customer name”, an “e-mail address” of the customer (through which e-mails can be received at the user terminal 300), a “product item” possessed by the customer (i.e. a product item that the customer has purchased from the sales company), a “phone number” or “address” of the customer and a “staff ID” for identifying the corresponding sales staff.

Such customer information includes information registered using a user-registration postcard, a facsimile, a telephone call, etc., after the customer has purchased a corresponding product item.

The member-information database 130 includes a re-writable storage device, such as a hard-disk device, etc., and stores the member information shown in FIG. 3B.

As illustrated in FIG. 3B, the sales-staff information includes information items of a “sales-staff ID” for identifying a corresponding sales staff, a “staff name”, an “area code” that the sales staff is in charge of, an “e-mail address” (through which e-mails can be received at the user terminal 300) and a “product item” possessed by the customer (i.e. information representing a product item that the customer has bought from a sales company, etc.), “contact information” including the customer phone number and address, etc., and a “staff ID” for identifying a corresponding sales staff.

The sales-staff information 140 includes a re-writable storage device, such as a hard disk device, etc., and stores staff information shown in FIG. 3C.

As shown in FIG. 3C, the staff information includes information items of a “staff ID” for identifying a corresponding sales staff, a “staff name”, an “area code” that the corresponding sales staff is in charge of, an “e-mail address” of the sales staff (through which e-mails can be received at the sales staff terminal 400) and a “product item” possessed that the sales staff is in charge of.

As illustrated in FIG. 2, the Web server 150 includes a server device including a controller, storage device, etc., creates Web pages including product information or member information, and provides the user terminal 300 with the created Web pages via the communications section 170. Particularly, the storage device of the Web server 150 stores a program for creating the Web pages. The controller of the Web server 150 executes this program to create Web pages including product information and member information and to update the created Web pages.

The e-mail server 160 includes a server device including a controller, a storage device and the like, and creates and sends an e-mail addressed to the sales staff (the sales-staff terminal 400). Specifically, the storage device of the e-mail server 160 stores in advance some set sentences or a template form of e-mails. The storage device of the e-mail server 160 stores also a program for sending and receiving e-mails. The controller of the e-mail server 160 executes this program, thereby creating e-mails using the set sentences or template. Further, the controller refers to the staff information, etc. shown in FIG. 3C, and sends an e-mail addressed to a corresponding sales staff (the sales-staff terminal 400).

The communications section 170 includes a communications device, such as a router or TA (a Terminal Adapter), for example. The communications section 170 sends and receives predetermined information to and from the user terminal 300 and the sales-staff terminal 400, through the communications network 200. Specifically, the communications section 170 can be accessed by the user terminal 300, and sends the Web pages created by the Web server 150 to the user terminal 300 having accessed the communications section 170. The communications section 170 sends the e-mails created by the e-mail server 160 to the sales-staff terminal 400 through the communications network 200.

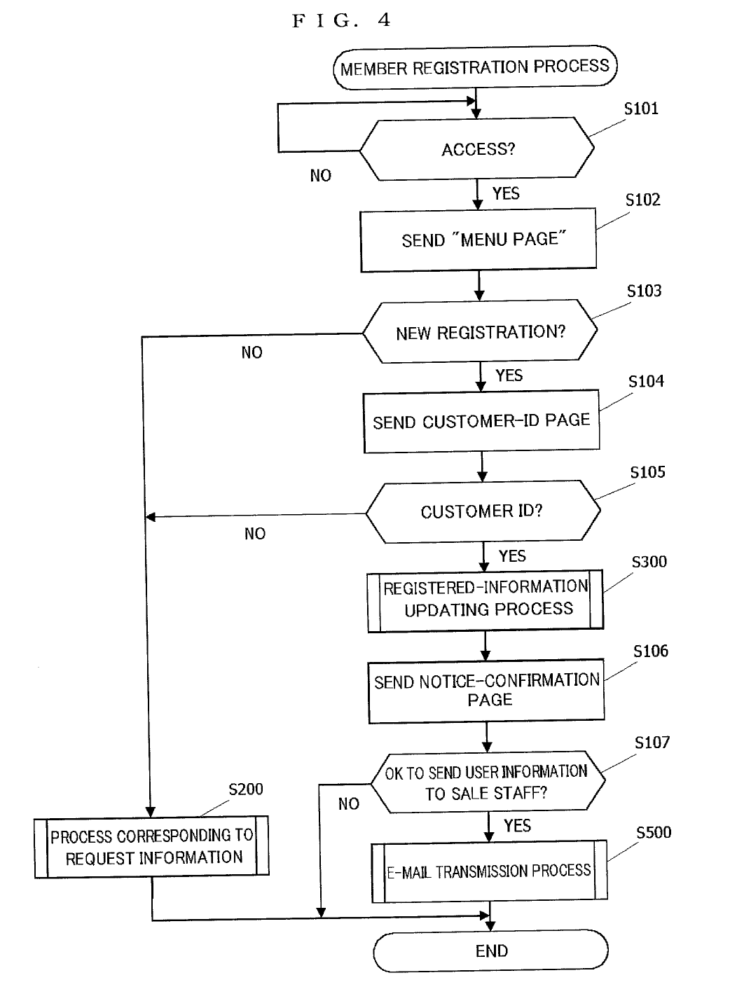

Operations of the member-registration support system according to the embodiment of the present invention will now be explained with reference to FIG. 4.

FIG. 4 is a flowchart for explaining a member registration process to be carried out by the controller 110 of the server 100. This process is executed in accordance with the program stored in advance in the memory of the controller 110. The server 100 provides a member-only Web site through which only registered members can get various services, so that non-registered users are to register themselves (online registration) on the Web site.

The controller 110 of the server 100 stands the user terminal 300 accessing the server 100 (Step S101).

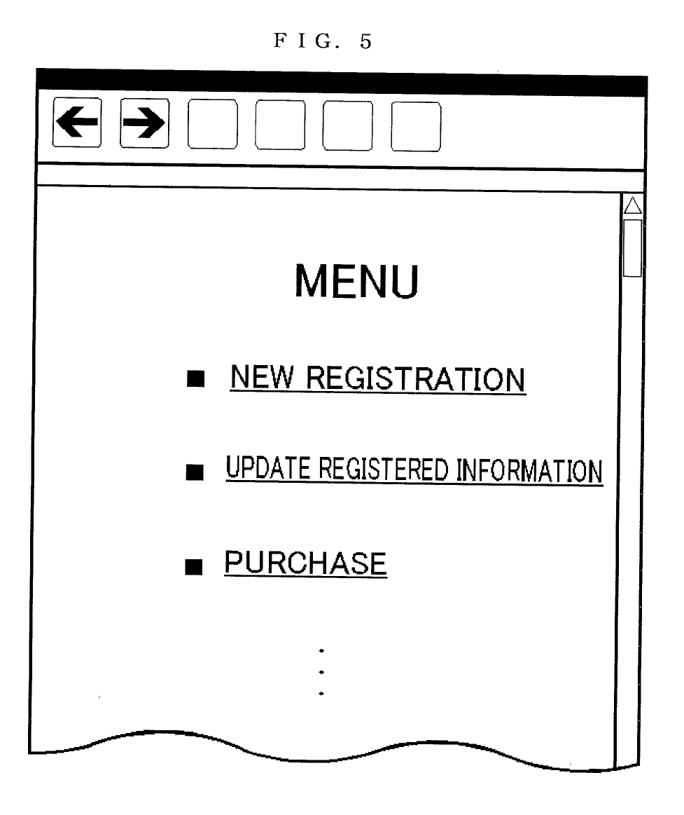

Immediately after the user terminal 300 accesses the server 100, the controller 110 sends a menu page to the user terminal 300 (Step S102). Specifically, upon reception of an access request from the user terminal 300 via the communications section 170, the controller 110 controls the Web server 150 to create a menu page shown in FIG. 5. The controller 10 sends this menu page to the user terminal 300 having sent the access request, via the communication section 170.

The user terminal 300 receives the menu page sent from the server 100, and displays the received menu page on the display section. As shown in FIG. 5, the menu page has several items of “new registration”, “update registered information”, “purchase”, etc. Note, in the illustration, the menu page shows several items in the hypertext form to be linked to another Web page. The item of “new registration” is linked to a Web page for registering the member information, the item of “update registered information” is linked to a Web page for updating member information, and the item of “purchase” is linked to a Web page for displaying product information, etc.

The customer selects a predetermined item on the menu page shown in FIG. 5 through the operation of the user terminal 300, so as to request the server 100 to sends a target Web page. That is, the user terminal 300 sends request information corresponding to the selected item to the server 100.

The controller 110 determines whether the item of “new registration” is selected by the user terminal 300 (Step S103). That is, the controller 300 determines whether request information corresponding to “new registration” is sent from the user terminal 300.

In the case where it is determined that the item of “new registration” has not been selected, the controller 110 executes a process corresponding to the sent request information (Step S200).

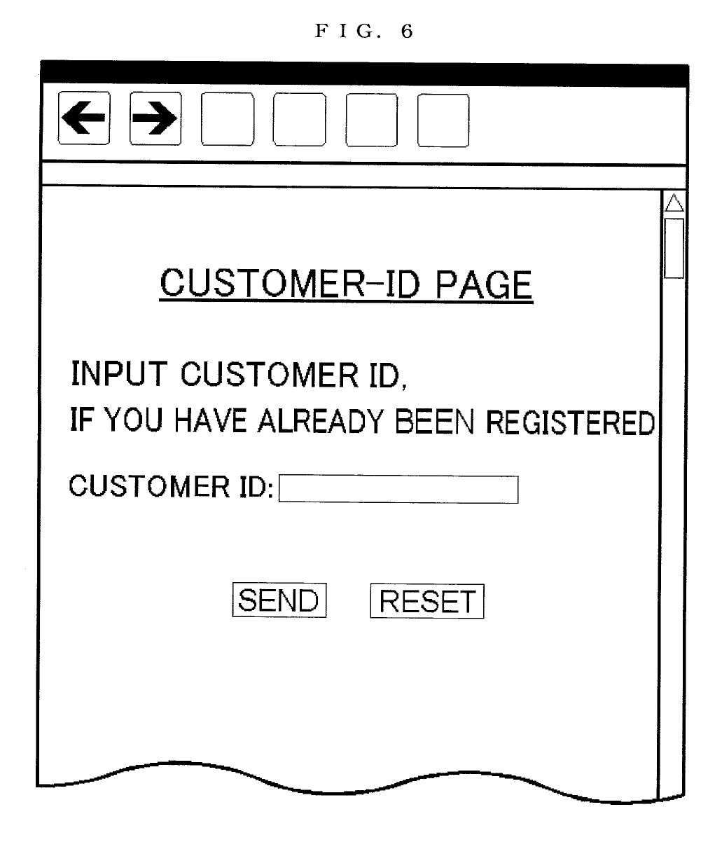

In the case where it is determined that the item of “new registration” has been selected, the controller 110 controls the Web server 150 to create a customer-ID page shown in FIG. 6, and sends the created customer-ID page to the user terminal 300 through the communications section 170 (Step S104).

The user terminal 300 receives the customer-ID page from the server 100, and displays the received page on its display section. As shown in FIG. 6, in the customer-ID page, there is arranged a text box for inputting a customer ID, for example.

In addition, in the customer ID page, there are arranged a “send” button and a “reset” button. For example, the “send” button is prepared for sending the customer ID input in the arranged text box (i.e. if information is input in the text box) or sending empty information (i.e. if no information is input in the text box) to the server 100, and is selected by the customer.

Specifically, if a customer has purchased a product item from a sales company before and the customer is registered as a user, a customer ID is sent to the customer. Such a customer inputs the sent customer ID into the text box, and selects the “send” box.

On the other hand, if the customer does not a customer ID, he/she selects the “send” button without inputting anything in the text box.

Upon selection of the “send” button, the controller 110 determines whether the customer ID is input in the text box (Step S105).

In the case where it is determined that no customer ID is input in the text box, the flow advances to step S200 wherein a process corresponding to the request information is executed.

In the case where it is determined that a customer ID is input in the text box, the controller 110 carries out a registered-information updating process of step S300.

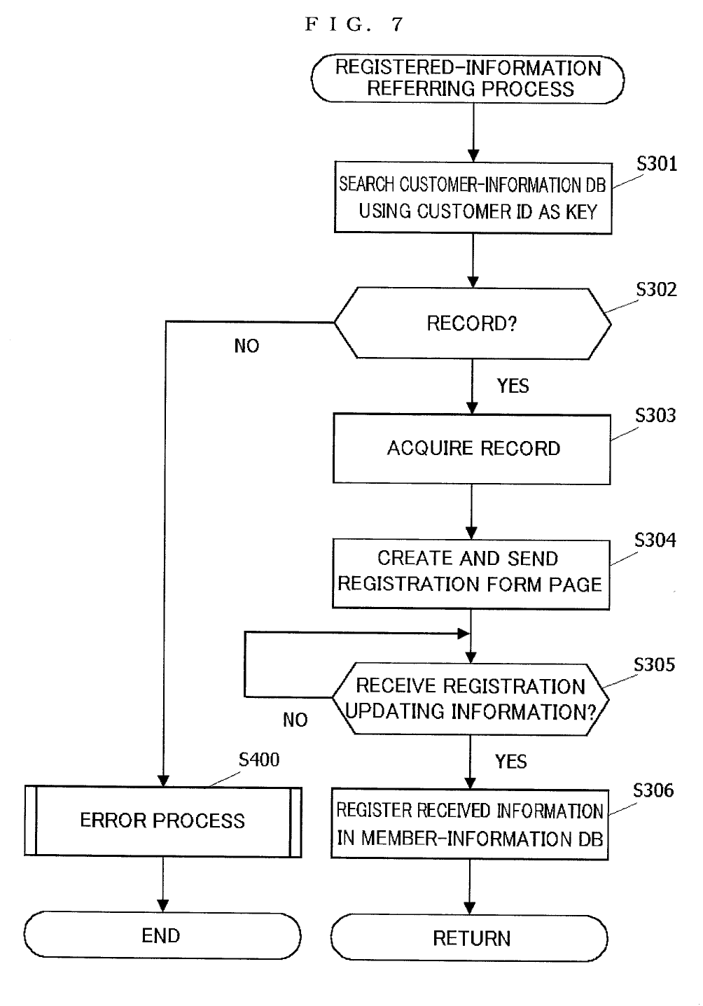

The registered-information updating process of the step S300 will now be described with reference to the flowchart shown in FIG. 7.

The controller 110 searches the customer-information database 120 for the customer ID input in the text box in the customer-ID page shown in FIG. 6 (Step S301).

The controller 110 determines whether a record (customer information) corresponding to the searched customer ID has been searched out (Step S302).

In the case where it is determined that the corresponding record has not been searched out, the controller 110 executes a predetermined error process (Step S400). For example, the controller 110 sends an error message for inquiring of the customer whether the input information is correct to the user terminal 300, and asks the customer to input again his/her customer ID.

On the contrary in the case where the corresponding record has successfully been searched out, the controller 110 acquires the record from the customer-information database 120 (Step S303).

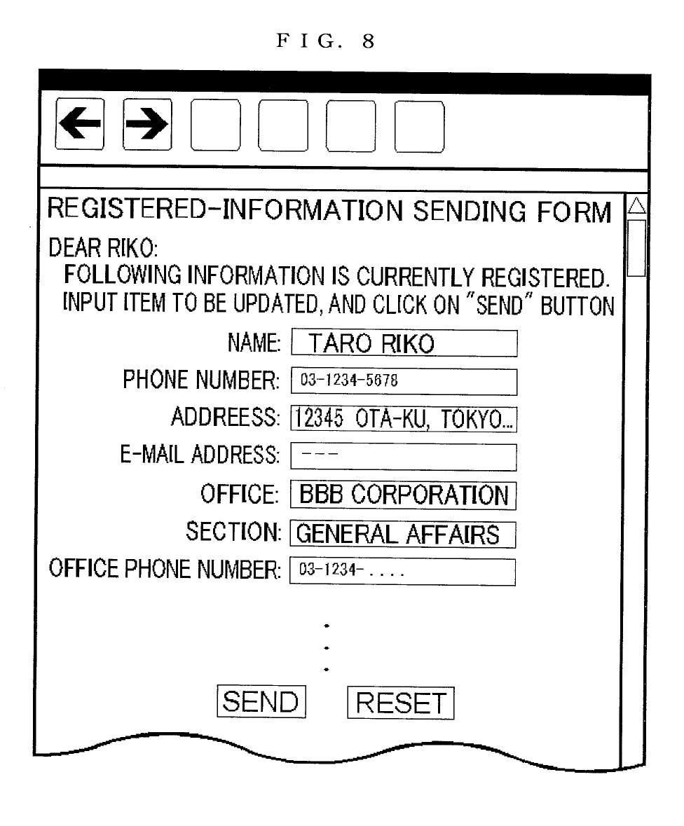

The controller 110 creates a registration form page, and sends the created page to the user terminal (Step S304). Specifically, the controller 110 provides the Web server 150 with the acquired record (i.e. the customer information corresponding to the customer ID), and instructs the Web server 150 to create a registered-information sending form. The Web server 150 creates a registered-information sending form based on the provided customer information, as shown in FIG. 8.

The controller 110 sends thus formed registered-information sending form to the user terminal 300.

Upon reception of the registered-information sending form from the server 100, the user terminal 300 displays the received form on its display section. As shown in FIG. 8, in this registered-information sending form, there are prepared several information pieces of “customer name”, “customer phone number”, “customer residential address”, “e-mail address”, “office name”, “section name”, “office phone number”, etc. Hence, it is not necessary that the customer input such information pieces every time the sending form is sent. In the case where the customer wants to update some information (such as his/her phone number, e-mail address, etc.) in the registered-information sending form, the customer update the information and selects the “send” button. In the case where it is not necessary to update the information pieces, the customer simply selects the “send” button.

The controller 110 waits until the “send” button is selected at the user terminal 300 and registration updating information (information for updating the registered information) is received (Step S305). That is, the controller 110 is not in action before receiving the registration updating information which represents the information contents input in the registered-information sending form.

Upon reception of the registration updating information, the controller 110 updates the member-information database 130 based on the received registration updating information (Step S306). The information contents of the registered-information sending form are updated by the customer at the user terminal 300, the controller 110 updates the member-information database 130 based on the updated registration updating information.

Upon completion of updating the member-information database 130, the flow returns to the member registration process shown in FIG. 4.

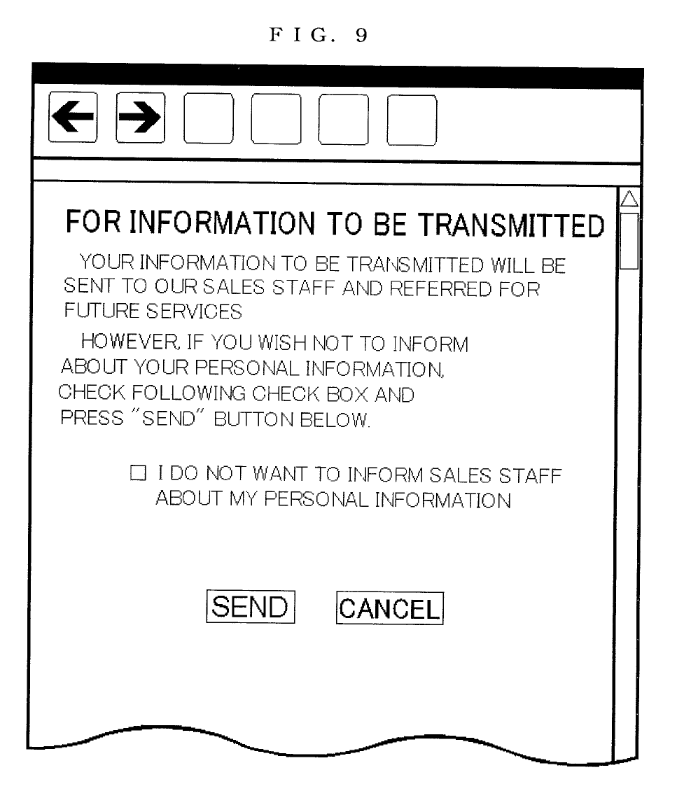

In FIG. 4, the controller 110 creates a notice-confirmation page and sends the created notice-confirmation page to the user terminal 300 (Step S106). Specifically, the controller 110 controls the Web server 150 to create the notice-confirmation page shown in FIG. 9, and sends the created notice-confirmation page to the user terminal 300 through the communications section 170.

The user terminal 300 receives the notice-confirmation page from the server 100, and displays the received page on its display section. As shown in FIG. 9, in this notice-confirmation page, there is a check box for confirming whether to send the customer information to a corresponding sales staff. Depending on whether the check box is marked, it is determined whether the request information sent form the user terminal 300 should be sent to the sales staff. That is, in the case where the check box is not marked, the contents of the request information is sent to the sales staff also, and will be used for future services. In the case where the check box is marked, the contents of the request information is not sent to the sales staff.

The notice-confirmation page has some buttons of “send” and “cancel”, as shown in FIG. 9. For example, the button of “send” is a button for requesting the transmission of the information input in the notice-confirmation form, and is selected by the customer.

If the “send” button is selected by the user terminal 300, the controller 110 determines whether the customer consents to informing the sales staff about the user information (Step S107). That is, the controller 110 determines whether the “send” button has been selected in a state where the check box is not marked by the user terminal 300 in the notice-confirmation page shown in FIG. 9.

In the case where it is determined that the customer does not consent to informing the sales staff about the user information, the controller 110 terminates the member registration process as is.

On the contrary, in the case where it is determined that the customer consents to informing the sales staff about the user information, the controller 110 carries out an e-mail transmission process of step S500.

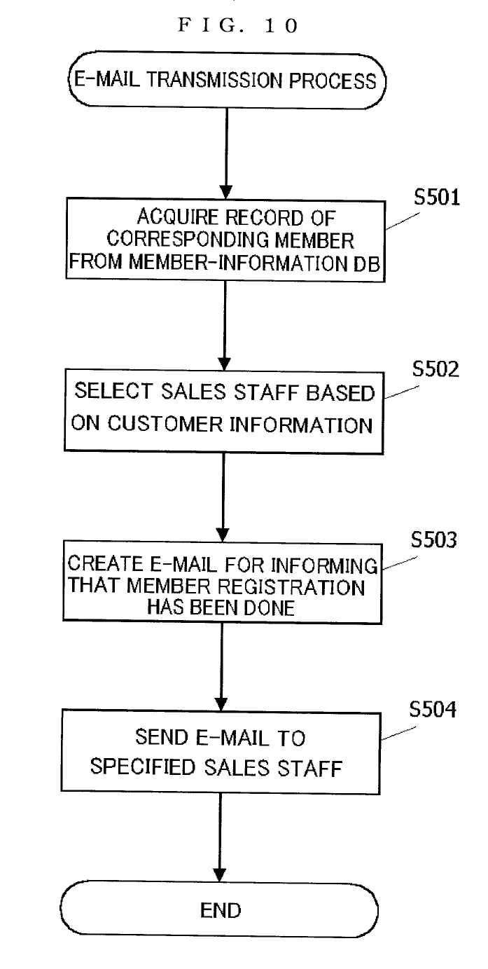

The e-mail transmission process S500 included in the product-sales information transmission process will now be explained with reference to the flowchart of FIG. 10.

The controller 110 accesses the member-information database 130, and acquires a corresponding record (corresponding member information) (Step S501).

The controller 110 selects a sales staff based on the customer information (Step S502). Specifically, the controller 110 acquires corresponding customer information from the customer-information database 120, using the customer ID as a key. In the case where the staff ID is set in the acquired customer information, the controller 110 selects the sales staff corresponding to the staff ID. In the case where the staff ID is not set in the acquired customer information, the controller 110 obtains a corresponding area code based on the contact information (such as the customer address, etc.) of the customer information, and acquires information representing a product item possessed by the customer. Then, the controller 110 searches the staff-information database 140, based on the obtained area code and the information representing the possessed product item, and selects a sales staff being in charge of the area and product item.

The controller 110 may select a corresponding sales staff based on the member information acquired in the step S501. In this case, if a staff ID is set in the acquired member information, the controller 110 selects a sales staff corresponding to staff ID. In the case where the staff ID is not set therein, the controller 110 searches the staff-information database 140 based on the area code and information representing the possessed product item, and selects the sales staff being in charge of the area and the product item.

The controller 110 provides the e-mail server 160 with the member information, and instructs the e-mail server 160 to create an e-mail representing that the member registration has been done (Step S503). In the case where the registered information received in the above-described step S305 is updated, the controller 110 instructs the e-mail server 160 to create an e-mail representing that the registered information is updated.

The controller 110 sends an e-mail to the selected sales staff (Step S504). Specifically, the controller 110 searches the staff-information database 140 for an e-mail corresponding to the staff ID of the selected sales staff. Then, the controller 110 sets the searched e-mail address as the addressee of the created e-mail. The controller 110 controls the e-mail server 160 to send the created e-mail to the sales staff.

The sales-staff terminal 400 detects the reception of the e-mail at a predetermined timing, retrieves the e-mail into the terminal and displays the retrieved e-mail in accordance with the operations of the sales staff. The sales staff specifies a corresponding customer based on the e-mail displayed on the sales-staff terminal 400 and makes contact with the specified customer for sales activities. For example, the sales staff performs sales activities for product items, expendables, option items, which may be related to the product item purchased by the customer.

According to the above member registration process, the registration of members is appropriately supported, and e-commerce and actual sales activities can be done in cooperation with each other.

In the above embodiment, upon reception of registered information from the user terminal 300, an e-mail is sent to the sales staff. However, the e-mail can be sent to the sales staff at any time other than the above case. For example, upon reception of purchase information for purchasing a product item from the user terminal 300, an e-mail may be sent to the sales staff.

The addressee of the e-mail to be sent is not limited to the sales staff and arbitrary. For example, in addition to the sales staff, the e-mail may be sent to one or more customer-information administrator of the sales company, etc.

In the above-described first embodiment, the explanations have been made to the case where the sales staff operates the sales-staff terminal 400. However, the present invention is not limited to this case, and can be employed in the case where sales-staff terminal 400 is operated by the service staff or maintenance staff, etc.

The system of the present invention can be realized by a general computer, without the need for a dedicated system. A program and data for controlling a computer to execute the above-described processes may be recorded on a medium (a floppy disk, CD-ROM, DVD or the like) and distributed, and the program may be installed into the computer and run on an OS (Operating System) to execute the above-described processes, thereby achieving the system of the present invention. The above program and data may be stored in a disk device or the like in the server device on the Internet, and embedded in a carrier wave. The program and data embedded in the carrier wave may be downloaded into the computer so as to realize the system of the present invention.

Various embodiments and changes may be made thereonto without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2001-020551 filed on Jan. 29, 2001, and including specification, claims, drawings and summary. The disclosure of the above Japanese Patent Application is incorporated herein by reference in its entirety.

What is claimed is:

1. A server device comprising:
a user-information storage section which stores in advance user information regarding at least one user to be a new member of a system;
a communications section which sends and receives predetermined information to and from at least one user terminal through a communications network;
an input-form sender which sends input-form information for inputting ID (identification) information for identifying said at least one user in a predetermined ID-form, to said at least one user terminal through said communications section;
an ID-information receiver which receives the ID information from said at least one user terminal through said communications section, in association with said input-form information sent by said input-form sender;
an information acquirer which acquires the user information corresponding to said at least one user from said user-information storage section, in association with the ID information received by said ID-information receiver;
a member-form sender which sends member-form information for inputting member information in a predetermined member-form together with the user information acquired by said information acquirer, to said at least one user terminal through said communications section;
a member-information receiver which receives the member information, sent from said at least one user terminal in association with said user information and member-form information sent by said member-form sender, through said communications section; and
a member-information storage section which stores the member information received by said member-information receiver.

2. A server device comprising:
a user-information storage section which stores in advance user information regarding at least one user to be a new member of a system;
a communications section which sends and receives predetermined information to and from at least one user terminal and at least one sales-staff terminal which are connected with each other through a communications network;
an input-form sender which sends input-form information for inputting ID information for identifying said at least one user in a predetermined ID-input form, to said at least one user terminal through said communications section;
an ID-information receiver which receives the ID information sent from said at least one user terminal in association with the input-form information sent by said input-form sender, through said communications section;
an information acquirer which acquires the user information corresponding to said at least one user from said user-information storage section, in association with the ID information received by said ID-information receiver;
a member-form sender which sends member-form information for inputting member information in a predetermined member form together with the user information acquired by said information acquirer, to the at least one user terminal through said communications section;
a member-information receiver which receives the member information, sent from said at least one user terminal in association with the user information and the member-form information sent by said member-form sender, through said communications section;
a member-information storage section which stores the member information received by said member-information receiver; and
a member-information sender which sends the member information received by said member-information receiver to said at least one sales-staff terminal through said communications section.

3. The server device according to claim 2, wherein:
each of said input-form sender and said member-form sender sends a Web page including form information to said at least one user terminal; and
said member-information sender sends an e-mail including the member information received by said member-information receiver to said at least one sales-staff terminal.

4. The server device according to claim 2, further comprising
a staff-information storage section which stores information regarding at least one sales staff, in association with the user information stored in said user-information storage section, and
wherein said information acquirer acquires the user information corresponding to the at least one user from said user-information storage section, and acquires the information regarding said at least one sales staff from said staff-information storage section, and
said member-information sender sets, as addressee, an e-mail address included in the information regarding said at least one sales staff and acquired by said information acquirer, and sends an e-mail including the member information acquired by said member-information receiver to said at least one sales staff terminal.

5. The server device according to claim 3, further comprising
a staff-information storage section which stores information regarding at least one sales staff, in association with the user information stored in said user-information storage section, and
wherein said information acquirer acquires the user information corresponding to the at least one user from said user-information storage section, and acquires the information regarding said at least one sales staff from said staff-information storage section, and
said member-information sender sets, as addressee, an e-mail address included in the information regarding said at least one sale staff and acquired by said information acquirer, and sends an e-mail including the member information acquired by said member-information receiver to said at least one sales staff terminal.

6. The server device according to claim 2, further comprising:
a confirmation-form sender which sends confirmation-form information for confirming whether to send the member information received by said member-information receiver to said at least one sales staff, to said at least one user terminal through said communications section; and
a confirmation-information receiver which receives confirmation information sent from said at least one user terminal in association with the confirmation-form information sent by said confirmation-form sender, through said communications section, and
wherein said member-information sender sends an e-mail including the member information received by said member-information receiver to said at least one sales-staff terminal, only in a case where said confirmation-information receiver receives the confirmation information for confirming whether to send the member information to said at least one sales staff.

7. The server device according to claim 3, further comprising:
a confirmation-form sender which sends confirmation-form information for confirming whether to send the member information received by said member-information receiver to said at least one sales staff, to said at least one user terminal through said communications section; and
a confirmation-information receiver which receives confirmation information sent from said at least one user terminal in association with the confirmation-form information sent by said confirmation-form sender, through said communications section, and
wherein said member-information sender sends an e-mail including the member information received by said member-information receiver to said at least one sales-staff terminal, only in a case where said confirmation-information receiver receives the confirmation information for confirming whether to send the member information to said at least one sales staff.

8. The server device according to claim 4, further comprising:
a confirmation-form sender which sends confirmation-form information for confirming whether to send the member information received by said member-information receiver to said at least one sales staff, to said at least one user terminal through said communications section; and
a confirmation-information receiver which receives confirmation information sent from said at least one user terminal in association with the confirmation-form information sent by said confirmation-form sender, through said communications section, and
wherein said member-information sender sends an e-mail including the member information received by said member-information receiver to said at least one sales-staff terminal, only in a case where said confirmation-information receiver receives the confirmation information for confirming whether to send the member information to said at least one sales staff.

9. A method for supporting member registration, comprising the steps of:
sending input-form information for inputting ID information for identifying at least one user, to at least one user terminal through a communications network;
receiving the ID information sent from said at least one user terminal in association with the input-form information sent at said step of sending the input-form information;
acquiring user information corresponding to said at least one user in association with the ID information received at said step of receiving the ID information, from a first storage section which stores in advance the user information regarding the at least one user to be a new member of a system;
sending member-form information for inputting member information in a predetermined member form together with the user information acquired at said step of acquiring the user information, to said at least one user terminal;
receiving the member information sent from said at least one user terminal in association with the member-form information and user information sent at said step of sending the member form; and
storing the member information received at said step of receiving the member information, in a second storage section storing information regarding at least one member.

10. A method for supporting member registration, comprising the steps of:
sending input-form information for inputting ID information for identifying at least one user in a predetermined ID form, to at least one user terminal through a communications network;
receiving the ID information sent form said at least one user terminal in association with the input-form information sent at said step of sending the input-form information;
acquiring user information corresponding to said at least one user terminal in association with the ID information received at said step of receiving the ID information, from a first storage section which stores in advance the user information regarding said at least one user to be a new member of a system;
sending member-form information for inputting member information in a predetermined member form together with the user information acquired at said step of acquiring the user information, to said at least one user terminal;
receiving the member information sent from said at least one user terminal in association with the member-form information and user information sent at said step of sending the member-form information;
storing the member information received at said step of receiving the member information, in a second storage section storing information regarding at least one member; and
sending member information received at said step of receiving the member information, to at least one sales-staff terminal through a communications network.

11. The method according to claim 10, wherein:
each of said step of sending the input-form information and said step of sending the member-form information includes a step of sending a Web page including form information to said at least one user terminal; and
said step of sending the member information includes a step of sending an e-mail including the member information received at said step of receiving the member information, to said at least one sales-staff terminal.

12. The method according to claim 10, wherein:
said step of acquiring the user information includes a step of acquiring the user information corresponding to said at least one user from said first storage section storing in advance the user information and a step of acquiring information regarding at least one sales staff corresponding to the user information from a third storage section storing information regarding at least one sales staff; and
said step of sending the member information includes a step of setting, as addressee, an e-mail address included in the information regarding the sales staff and acquired at said step of acquiring the information and a step of sending an e-mail including the member information acquired at said step of receiving the member information to said at least one sales staff.

13. The method according to claim 11, wherein:
said step of acquiring the user information includes a step of acquiring the user information corresponding to said at least one user from said first storage section storing in advance the user information and a step of acquiring information regarding at least one sales staff corresponding to the user information from a third storage section storing information regarding at least one sales staff; and
said step of sending the member information includes a step of setting, as addressee, an e-mail address included in the information regarding the sales staff and acquired at said step of acquiring the information and a step of sending an e-mail including the member information acquired at said step of receiving the member information to said at least one sales staff.

14. The method according to claim 10, further comprising the steps of:
sending confirmation-form information for confirming whether to send the member information received at said step of receiving the member information to said at least one sales staff, to said at least one user terminal; and
receiving confirmation information received from said at least one user terminal in association with the confirmation-form information sent at said step of sending the confirmation-form information, and
wherein said step of sending the member information includes a step of sending an e-mail including the member information received at said step of receiving the member information to said at least one sales-staff terminal, only in a case where the confirmation information for confirming whether to send the member information to said at least one sales staff is received at said step of receiving the confirmation information.

15. The method according to claim 11, further comprising the steps of:
sending confirmation-form information for confirming whether to send the member information received at said step of receiving the member information to said at least one sales staff, to said at least one user terminal; and
receiving confirmation information received from said at least one user terminal in association with the confirmation-form information sent at said step of sending the confirmation-form information, and
wherein said step of sending the member information includes a step of sending an e-mail including the member information received at said step of receiving the member information to said at least one sales-staff terminal, only in a case where the confirmation information for confirming whether to send the member information to said at least one sales staff is received at said step of receiving the confirmation information.

16. The method according to claim 12, further comprising the steps of:
sending confirmation-form information for confirming whether to send the member information received at said step of receiving the member information to said at least one sales staff, to said at least one user terminal; and
receiving confirmation information received from said at least one user terminal in association with the confirmation-form information sent at said step of sending the confirmation-form information, and
wherein said step of sending the member information includes a step of sending an e-mail including the member information received at said step of receiving the member information to said at least one sales-staff terminal, only in a case where the confirmation information for confirming whether to send the member information to said at least one sales staff is received at said step of receiving the confirmation information.

17. A computer readable recording medium recording a program for controlling a computer to execute a method for supporting member registration, and said method comprising the steps of:
sending input-form information for inputting ID information for identifying at least one user, to at least one user terminal through a communications network;
receiving the ID information sent from said at least one user terminal in association with the input-form information sent at said step of sending the input-form information;
acquiring user information corresponding to said at least one user in association with the ID information received at said step of receiving the ID information, from a first storage section which stores in advance the user information regarding the at least one user to be a new member of a system;
sending member-form information for inputting member information in a predetermined member form together with the user information acquired at said step of acquiring the user information, to said at least one user terminal;
receiving the member information sent from said at least one user terminal in association with the member-form information and user information sent at said step of sending the member form; and
storing the member information received at said step of receiving the member information, in a second storage section storing information regarding at least one member.

18. A computer readable recording medium recording a program for controlling a computer to execute a method for supporting member registration, and said method comprising the steps of:
sending input-form information for inputting ID information for identifying at least one user in a predetermined ID form, to at least one user terminal through a communications network;
receiving the ID information sent form said at least one user terminal in association with the input-form information sent at said step of sending the input-form information;
acquiring user information corresponding to said at least one user terminal in association with the ID information received at said step of receiving the ID information, from a first storage section which stores in advance the user information regarding said at least one user to be a new member of a system;
sending member-form information for inputting member information in a predetermined member form together with the user information acquired at said step of acquiring the user information, to said at least one user terminal;
receiving the member information sent from said at least one user terminal in association with the member-form information and user information sent at said step of sending the member-form information;
storing the member information received at said step of receiving the member information, in a second storage section storing information regarding at least one member; and
sending member information received at said step of receiving the member information, to at least one sales-staff terminal through a communications network.

19. A computer data signal embodied in a carrier wave and representing an instruction sequence for controlling a computer to execute a method for supporting member registration, and said method comprising the steps of:
sending input-form information for inputting ID information for identifying at least one user, to at least one user terminal through a communications network;
receiving the ID information sent from said at least one user terminal in association with the input-form information sent at said step of sending the input-form information;
acquiring user information corresponding to said at least one user in association with the ID information received at said step of receiving the ID information, from a first storage section which stores in advance the user information regarding the at least one user to be a new member of a system;
sending member-form information for inputting member information in a predetermined member form together with the user information acquired at said step of acquiring the user information, to said at least one user terminal;
receiving the member information sent from said at least one user terminal in association with the member-form information and user information sent at said step of sending the member form; and
storing the member information received at said step of receiving the member information, in a second storage section storing information regarding at least one member.

20. A computer data signal embodied in a carrier wave and representing an instruction sequence for controlling a computer to execute a method for supporting member registration, and said method comprising the steps of:
sending input-form information for inputting ID information for identifying at least one user in a predetermined ID form, to at least one user terminal through a communications network;
receiving the ID information sent form said at least one user terminal in association with the input-form information sent at said step of sending the input-form information;
acquiring user information corresponding to said at least one user terminal in association with the ID information received at said step of receiving the ID information, from a first storage section which stores in advance the user information regarding said at least one user to be a new member of a system;
sending member-form information for inputting member information in a predetermined member form together with the user information acquired at said step of acquiring the user information, to said at least one user terminal;
receiving the member information sent from said at least one user terminal in association with the member-form information and user information sent at said step of sending the member-form information;
storing the member information received at said step of receiving the member information, in a second storage section storing information regarding at least one member; and
sending member information received at said step of receiving the member information, to at least one sales-staff terminal through a communications network.
